(19) United States
(12) Patent Application Publication
(10) Pub. No.: US 2011/0302906 A1
(43) Pub. Date: Dec. 15, 2011

(54) Laser Tractor Beam

(76) Inventors: John Elihu Sinko, St. Cloud, MN (US); Clifford Adam Schlecht, Glastonbury, CT (US)

(21) Appl. No.: 13/161,407

(22) Filed: Jun. 15, 2011

Related U.S. Application Data
(60) Provisional application No. 61/354,768, filed on Jun. 15, 2010.

(51) Int. Cl. B64G 1/40

(52) U.S. Cl. 60/204

(57) ABSTRACT

There is provided a method of using a remote laser source to manipulate a space object having a target, comprising projecting a beam from the remote laser source, wherein the beam has a sufficient intensity and wavelength to cause ablation at a position on the target; imparting an impulse to the space object having the target; modifying at least one beam characteristic selected from the group consisting of intensity, wavelength and position on the target, wherein the position and/or orientation of the space object is altered relative to the remote laser source.

### CROSS-REFERENCE TO PRIOR APPLICATIONS

This application claims priority to U.S. Provisional Patent Application 61/354,768 filed Jun. 15, 2010, which is incorporated herein by reference in its entirety.

### FIELD

The present disclosure relates to a tractor beam system, particularly to a tractor beam system using laser ablation on a target of a space object.

### BACKGROUND

Because scale, distance, or impulse (thrust) limit current technologies, a space tractor beam system constitutes a paradigm shift in how space and space systems are used. Field-propulsion systems, such as laser tweezers, typically operate on micron- to nanometer-scale targets. Magnetic tractor beams are severely limited in range. Power-beaming with conventional propulsion systems can produce tractor-beam-like effects, but the beam itself does not produce significant impulse.

Research on laser ablation propulsion has been conducted worldwide in atmospheric and simulated space environment conditions. Many technical challenges such as beam riding, target tracking and choice of target materials have been overcome. Despite these efforts, laser propulsion is uneconomical when applied to traditional propulsion applications. Chemical rocket propulsion seems appropriate for launch from ground to orbit, and electric propulsion is well suited for most space missions. Therefore, applications for laser propulsion are sought to emphasize its strengths, including finely adjustable impulse bit (nNs to Ns), adjustable specific impulse (Iₛₚ) (about 100 to about 3600 seconds), and remote operation. Specifically in laser propulsion, the power source can be separated from the vehicle, enabling operation from a remote location, which is impossible with conventional thrusters.

Phipps (“Laser-powered, Multi-newton Thrust Space Engine with Variable Specific Impulse,” High-Power Laser Ablation VII, Proceedings of SPIE, Vol. 7005, 2008, pp. 1X, 1-8; “Very High Coupling Coefficients at Low Laser Fluence with a Structured Target,” High-Power Laser Ablation III, Proceedings of SPIE, Vol. 4065, Santa Fe, N. Mex., 2000, pp. 931-938; “A Diode-laser-driven Microthruster,” National Space Grant Foundation, Paper IEPC-01-220, October 2001) describes multi-layer laser ablation propellants and a laser thruster. Initially low-fluence laser light is focused through a transparent substrate layer to generate confined ablation of a second layer. The microthruster can operate bidirectionally, but such operation impairs the optics by depositing ablated exhaust during driving-mode operation. In this system, the laser and necessary optics are onboard and therefore the thruster operation does not constitute remote control as in a laser tractor beam as defined herein.

Rezunov et al. (“Investigations of Propelling of Objects by Light: Review of Russian Studies on Laser Propulsion,” Third International Symposium on Beamed Energy Propulsion, AIP Conference Proceedings, Vol. 766, 2005, pp. 46-57; “Performance Characteristics of Propulsion Engine Operating both in CW and in Repetitively-Pulsed Modes,” Fourth International Symposium on Beamed Energy Propulsion, AIP Conference Proceedings, Vol. 802, Nara, Japan, 2005, pp. 3-13) describe a laser jet engine. Experiments use impulse from CO₂ laser ablation and exhaust combustion to drive a wire-guided laser jet engine craft towards the laser beam for a distance of some meters, using polymer or liquid propellants and operating in atmosphere or under vacuum.

### SUMMARY OF INVENTION

There is provided in this disclosure a method for manipulating a space object using a remote laser source, comprising:
projecting a beam of sufficient intensity and wavelength to cause ablation at a position on a target;
imparting an impulse to the target;
modifying the impulse, intensity, wavelength, and/or position on the target to control the position and/or orientation of the space object relative to the remote laser source.

In some embodiments the space object is pushed relative to the remote laser source. In other embodiments, the space object is pulled relative to a remote laser source. In some other embodiments, a torque is applied to the space object relative to the remote laser source. In a particular embodiment, the torque turns the target into a proper alignment with the beam. In some embodiments the thrust directional parity of the target is switched.

In some embodiments, at least a first remote laser source and a second remote laser source are projected. In other embodiments each laser has a different intensity, wavelength, and/or position on the target.

In some embodiments, the target comprises a first layer that is transparent to the wavelength of the first remote laser source. In a particular aspect of this embodiment, the target comprises a first layer of transparent solid material comprising an array of microlenses and a second layer of solid material which is absorbing at the laser wavelength. In another aspect of this embodiment, the target comprises a first layer with a high threshold fluence for ablation, and a second layer with a low threshold fluence for ablation.

In some embodiments the target extends away from the space object. In other embodiments, the target is contained within a central ring on the space object.

In some embodiments, the method further comprises transmitting information between the remote laser source and the space object.

In some embodiments, the space object is selected from the group consisting of satellite, spacecraft, telescope, astronaut, space debris, asteroid, equipment, arrayed satellite, and arrayed telescope.

There is also provided in this disclosure an ablation target, comprising a first layer with a high threshold fluence for ablation, and a second layer with a low threshold fluence for ablation of a remote laser source. In some embodiments, the first layer is transparent to a wavelength of the beam. In a particular aspect of this embodiment, the first layer comprises polyethylene and the second layer comprises polyoxymethylene. In another aspect of this embodiment, the first layer and the second layer are joined together by an adhesive. In another aspect of this embodiment, the remote laser source is a Nd:YAG laser or the beam has a wavelength of 10.6 μm.

### BRIEF DESCRIPTION OF FIGURES

FIG. 1 shows conceptual diagrams, in cross-section, of indirect laser propulsion tractor-beam targets. FIG. 1a shows a target with a central concentrator and peripheral ablator; FIG. 1b shows a peripheral concentrator and central ablator, and FIG. 1c is an asymmetric system. Gray arrows indicate direction of ablation exhaust.

FIG. 2 shows examples of two-layer targets in terms of wavelengths λ₁ and λ₂ and fluences Φ₁ and Φ₂.

FIG. 3 shows an experimental setup to demonstrate tractor beam propulsion.

Both FIG. 4(a) and FIG. 4(b) show driving mode impulse followed by tractor beam impulse on Target 2. The dark line is a FFT-low pass (0.4 Hz) filtered trace of the result to illustrate the magnitude of impulse delivery.

FIG. 5 shows Φ (z), assuming output aperture radius of the lasers source (W_{L}) is 0.05 m, E=100 J, M²≈10 for 10600 nm, and M²≈2 for all other wavelengths.

FIG. 6 shows extrapolated 1 kg propellant mass lifetime vs. average thrust at 1 Hz repetitively pulsed (rp) using constant m and I based on experimental data for focused CO₂ laser ablation of flat plates of polyoxymethylene in vacuum.

FIG. 7 shows propellant consumption of the target as a function of range (M²≈10 for 10600 nm, and M²≈2 for other wavelengths).

FIG. 8 shows impulse as a function of range (M²≈10 for 10600 nm, and M²≈2 for all other wavelengths)

FIG. 9 shows a method for generating reversed thrust with a cooperative target for (a) forward thrust and (b) reverse thrust.

FIG. 10 shows (a) a cooperative target for astronaut retrieval, (b) several targets applied to an EMU-like spacesuit, and (c) steps for astronaut retrieval, including (i) drifting astronaut, (ii) irradiating at λ₂ accelerates astronaut towards the station, and (iii) irradiating at λ₁ decelerates astronaut for safe retrieval.

### DETAILED DESCRIPTION

Hereinafter, preferred embodiments of the present invention will be described in detail with reference to the accompanying drawings. It should be understood that the detailed description of the preferred embodiments of the invention are given by way of illustration only, and accordingly various changes and modifications within the spirit and scope of the invention will become apparent to those skilled in the art.

Herein, “tractor beam” refers to a beam of energy that imparts impulse to a remote object of interest, such as a space object, to enable remote control. Potential applications include orbital debris removal, spacecraft rendezvous, satellite attitude and orbital adjustment, equipment retrieval, and redundant systems for space rescue. A remote energy source can be directed in the form of a beam, and subsequently absorbed or collected at a target, imparting impulse (thrust) to that target. The degree to which the energy source is remote and the mechanism for imparting thrust can vary and therefore do not limit the operation of a tractor beam as described herein. The main purpose of a tractor beam is to enable remote control of distant objects. “Remote control” includes, but is not limited to, thrust in a single direction, and multidimensional control of the velocity, position, and rotational axes of an object.

Targets

Targets comprise a structure, composition, and/or geometry which enables selection of either reverse or forward thrust and throttle control in real time in response to changes in remote laser beam parameters. Cooperative targets can be indirect cooperative targets or direct cooperative targets.

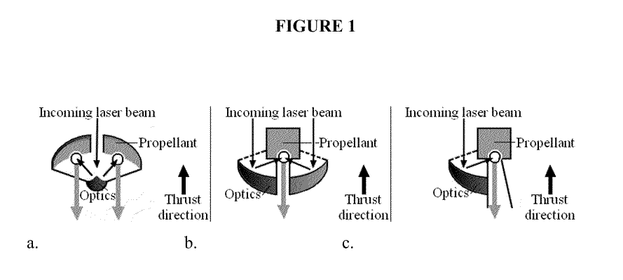

Indirect cooperative targets redirect the laser beam, for example with lenses, mirrors, or fiber optics, to the rear of the target to produce tractor beam propulsion without allowing the beam to pass directly through the target material itself. Some examples are shown in FIG. 1. Black arrows denote the path of the laser light (the remote source is not shown), circled areas denote ablation, and gray arrows denote exhausted propellant. The target shown in FIG. 1c is asymmetric, and can be used to impart torque to an object. Alternatively, several targets mounted around a single object can be ablated in sequence to produce a net linear thrust, somewhat akin to the operation of a kayak or canoe. Efficiency can be reduced because significant energy is directed to adjust angular momentum at each shot.

By modifying the laser profile or selecting between irradiation of the center and edges of the targets, each of the above systems can be switched between driving and tractor-beam propulsion at the whim of a remote operator. Additionally, indirect systems focus laser light after it arrives at the craft, enabling operation at low incident power levels, thereby reducing the likelihood of damage to any space systems that are accidentally illuminated by the laser beam and of use of the laser source as a weapon.

Direct targets can transmit the laser beam through a transparent target material to facilitate absorption at a second material and confined ablation at the interface between the two materials, resulting in tractor-beam propulsion. Direct targets may not be purely confined systems. In driving mode, they can operate by ablation at the front surface of the target. In some embodiments, an unfocused laser beam can be used for both tractor-beam and driving modes. Other embodiments rely on focusing the beam for one or both modes.

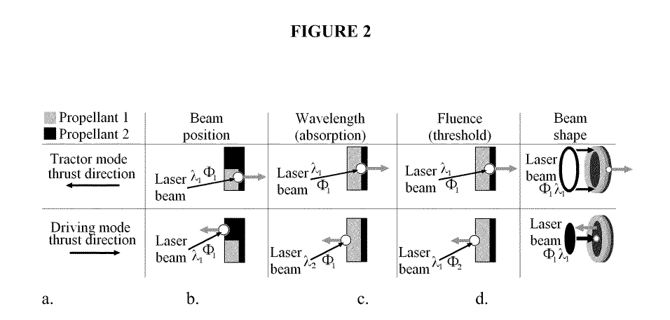

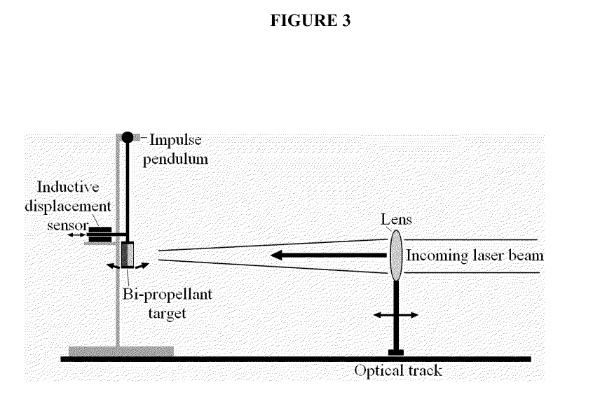

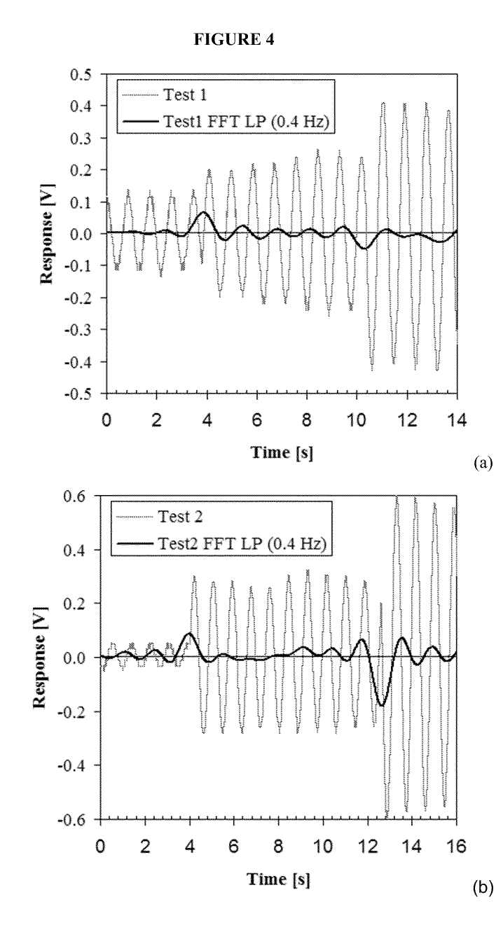

For direct systems, thrust parity (i.e., towards or away from the laser source), as well as thrust vectoring, can be controlled in several ways. At the target, the propellant or propellant geometry can be varied, but these parameters are typically fixed during a mission. At the laser source, the wavelength, fluence (pulse energy/spot area), beam position on the target, and beam spatial profile can be modified in real time. Because of the abundance of control parameters, many types of direct targets are possible, including single-layer, two-layer, and multi-layer targets. Some examples of two-layer targets are shown in FIG. 2 in terms of wavelengths λ₁ and λ₂ and fluences Φ₁ and Φ₂.

FIG. 2a shows thrust parity selection based on the laser beam position on a spatially patterned target, enabling tractor-beam (top) or driving (bottom) propulsion. Torque can also be imparted, facilitating attitude control. Targeting and beam divergence become crucial as the distance from the laser source increases as do the sizes of the target and laser source apertures.

FIG. 2b shows thrust parity selection by laser wavelength for tractor-beam (top) or driving (bottom) propulsion. This embodiment uses at least 2 laser wavelengths λ₁ and λ₂. At a minimum, the first propellant should be transparent at λ₁ and strongly absorbing at λ₂. In principle the second propellant need only be strongly absorbing at λ₁, but if it were also transparent at λ₂, the target could be remotely controlled from two directions, e.g., enabling redundant guided target transfer between two laser stations.

FIG. 2c shows thrust parity selection by fluence. At low fluence (top) the laser beam passes through a first material with a high ablation threshold and impinges on a second material with a low ablation threshold. Confined ablation of the second layer produces tractor beam propulsion. At high fluence (bottom), the laser beam exceeds the first ablation threshold, generating driving propulsion.

FIG. 2d shows a structured target similar to FIG. 2a, but in this case, the laser beam remains centered, and is merely switched between operational modes to generate different beam profiles. For instance, a CO₂ laser could be switched between stable oscillator (quasi-TEM₀₀) and unstable oscillator (washer) modes to select tractor-beam (top) or driving propulsion (bottom), especially when used at close range. An asymmetric laser beam profile incident on this target could generate torque for attitude control.

For direct targets, target parameters include material and geometry, and adjustable control parameters at the laser source include beam position at the target, fluence, wavelength, and laser beam spatial profile. Application of thrust and torque to remote targets is possible in real time, facilitating novel space applications. The laser can be a solid state crystal laser, such as neodymium-doped yttrium aluminum garnet (Nd:YAG), erbium-doped YAG (Er:YAG), neodymium-doped yttrium lithium fluoride (Nd:YLF), Nd:YCa₄O, Nd:Glass, Ti:sapphire, thulium-doped YAG (Tm:YAG), Ho:YAG, cerium-doped lithium calcium fluoride (Ce:LiCaF) U:CaF₂, Sm:CaF₂ and Nd:YVO₄; a gas phase laser such as CO₂, CO, F₂, N₂, KrF, Ar₂, Kr₂, Xe₂, ArF, KrF, XeBr, XeCl, XeF, KrCl; a diode laser or dye laser. Given the large pulse energy and average power operation of CO₂, Nd:YAG and KrF lasers, they could be good candidates to drive such a system, if reliable operation in space can be achieved.

A target can comprise one or more propellents including, but not limited to, polyoxymethylene (POM, Delrin™, paraformaldehyde), polyamide (PA, Nylon™ 6/6), polycarbonate (PC), polyethylene terephthalate (PET); polyalkylene glycol, such as polyethylene glycol (PEG), polypropylene glycol (PPE), polyethylene terephthalate glycol (PETG), and polypropylene terephthalate glycol (PPTG); polychlorotrifluouroethylene (PCTFE), polymeth-acrylate (PMA), polymethylmethacrylate (PMMA), polystyrene (PS), polytetrafluoroethylene (PTFE), polyvinylchloride (PVC), polyurethane, and polyalkylenes such as polyethylene and polypropylene.

“Alkylene” refers a divalent, branched or unbranched, substituted or unsubstituted, hydrocarbyl fragment. Examples of alkylenes include, for example,

methylene (—CH₂—),

ethylene (—CH₂CH₂—),

propylene (—CH₂CH₂CH₂—),

butylene (—CH₂CH₂CH₂CH₂—),

pentylene (—CH₂CH₂CH₂CH₂CH₂—),

hexylene (—CH₂CH₂CH₂CH₂CH₂CH₂—),

heptylene (—CH₂CH₂CH₂CH₂CH₂CH₂CH₂—),

octylene (—CH₂CH₂CH₂CH₂CH₂CH₂CH₂CH₂—),

nonylene, (—CH₂CH₂CH₂CH₂CH₂CH₂CH₂CH₂CH₂—) and

decylene (—CH₂CH₂CH₂CH₂CH₂CH₂CH₂CH₂CH₂CH₂—).

Absorbing polymers typically have lower thresholds for ablation. For 10.6 micron wavelength (CO₂ laser), polymers with high thresholds include, but are not limited to, PTFE, PET, PETG, and PE. Polymers with low thresholds at this wavelength include, but are not limited to, POM and PCTFE. Intermediate thresholds for common polymers include PC and PMMA.

The target can comprise a propellant that is high density, for example high-density polyethylene (HDPE, HPPE), or low density, for example low-density polyethylene (LDPE, LPPE); ultrahigh molecular weight, such as ultrahigh molecular weight polyethylene (UMHW PE); amorphous or crystalline; solid, liquid or gel. The propellant can be undoped or doped with an absorbant material to enhance absorption. An example of such an absorbant material is carbon; thus, the propellant can be, for example, polyoxymethylene doped with carbon (POM:C) with about 1% to about 25% carbon, such as about 20% carbon, about 15% carbon, about 10% carbon, about 5% carbon, about 4% carbon, about 3% carbon, or about 2% carbon.

Layered Targets

A two-layer laser ablation propulsion tractor-beam target comprises a structured propellant. For example, a two-layer cooperative target comprises one transparent and one absorbing layer of material, optionally bonded together by an adhesive. Such a two-layer target does not require concentrating optics for the target to function at close range, even when concentration may be necessary for long-range space applications at about 10 to about 1000 km. Even when concentration is not necessary, use of concentration at the target may be both physically and politically beneficial, since the requirement for the fluence of the source laser beam is reduced. Lower fluence beam transmission can reduce and possibly eliminate international concerns about the use of such a system as a space-based weapon. Collateral damage to other structures which may accidentally intersect the laser beam, for example satellites, astronauts or airplanes, can be minimized when low-fluence operation is used. In addition, heat management is easier, and damage to optics is minimized in the low-fluence regime.

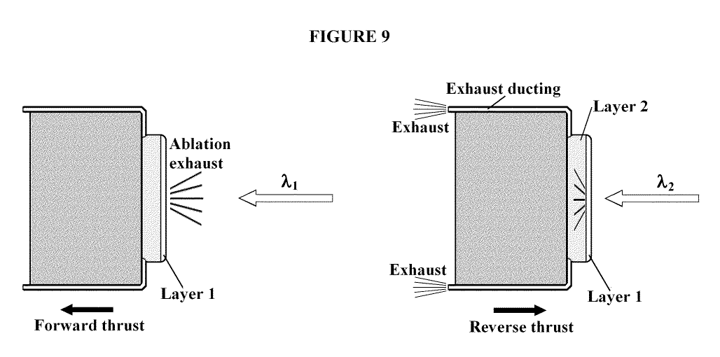

In FIG. 9a, a laser beam of wavelength λ₁ is incident from the right and strikes Layer 1, producing direct ablation and forward thrust. In FIG. 9b, a laser beam of wavelength λ₂ is used on the same target. Layer 1 is transparent to the laser beam, but Layer 2 is absorbing, so ablation occurs internally, and gaseous exhaust is redirected to the rear, producing reverse thrust.

Specific embodiments of two-layer propellant are selected by matching absorption peaks and windows in appropriate materials to the spectral lines of the laser system, maximizing energy deposition and impulse generation. A two-layer target can be purposefully switched between forward and reverse thrust modes merely by changing laser parameters. Layers can be, for example, a solid, gel, paste, or liquid propellant, while the other layer is solid. A two-layer propellant is an improvement over other ablation targets because a single target, if designed properly, can be used from either direction in either driving or traction mode. Two separate laser stations can simultaneously apply lasers, controlling and adjusting the imparted impulse.

Any two propellants described herein are suitable for a two-layer target. In a particular embodiment, the first layer of a two-layer target can be PE or PTFE with a thickness of about 10 μm to about 1250 μm, for example about 760 μm to about 1000 μm, from about 10 to about 100 μm, or from about 10 to about 50 μm, and the second layer of a two-layer target can be POM with a thickness of about 10 μm to about 1250 μm, for example 125 μm to about 250 μm, from about 10 to about 100 μm, or from about 10 to about 50 μm.

The two layers of the two-layer target can be joined together for example, by hot-melt extrusion, lamination, partial dissolution of one polymer layer into the other, or with chemical adhesive, for example acrylate or cyanoacrylate.

Tractor Beams

Ultimate realization of a tractor beam may be called a “science fiction tractor beam” capable of remotely manipulating virtually any object, for example, spacecraft, aircraft, or people. Although it is definitely possible to levitate objects against the Earth's gravitational force (e.g., magnetic levitation trains), so far large magnetic fields or massive equipment are required and are only effective at very close range. In reality, a science fiction tractor beam is unlikely to be efficient enough to be feasible. Therefore, this disclosure considers features of tractor beam systems that are most useful and achievable.

A tractor beam is produced by an energy source remote from the target. For macroscopic purposes, such as laser space debris removal or spacecraft control, operation can be at distances of about 1 m to about 10000 km between the source and target. This requirement is limiting because there are very few ways to interact with a target across such a range of distances, even by using a laser beam or a microwave beam. Magnetic field propulsion is excluded, but other remote energy sources, such as particle beams, kinetic projectiles, and electromagnetic beams, for example visible light, infrared radiation, ultraviolet radiation, microwaves, and radar can be used. Maximum operational range from an energy source is a complex issue, depending, for instance, on the cooperation of target, beam divergence, diffraction, and attenuation.

A magnetic tractor beam system can use multidimensional fields to manipulate a target; however, in a microscopic sense, a laser beam also subjects a target to electromagnetic energy fields. This is a separate issue from whether the source is remote, since a beamed source might also be used to manipulate an object that was very close, as has been demonstrated in laser tweezers. As can be seen, beam-like characteristics tend to support long-range operation.

A distinguishing feature of a tractor beam is the method used to impart thrust. In some cases, impulse can be indirectly imparted by depositing energy in the surrounding atmosphere. This method is directed to space applications, however, because there is little ambient matter, leaving the beam to interact directly with the target. Science fiction tractor beams appear to transfer energy directly into the motion of the target. In real life, a mechanism is needed for such an energy transfer. In general, these may only be kinetic, electric, magnetic, or gravitational. The strong and weak forces are highly local and do not seem easily accessible for the purpose of tractor beams. Gravitational forces have long range, but are impaired by the requirement of a “beam” capable of manipulating significant mass; for example, even a kind of “gravity beam” of dense particles passing nearby would have insignificant influence on a macroscopic object, such as a satellite, on any reasonable timescale. Large, slow-moving kinetic projectiles might have an effect (a “gravity tug”), but are far afield from a tractor beam. Magnetic thrust is difficult to achieve and control at long range. Electric thrust mechanisms include, for example, beams of ionized particles and electromagnetic waves; that is, beamed energy, which is suitable for the method of the present disclosure.

A tractor beam target can be powered, power-receptive, or unpowered. A powered target has its own power supply, including, but not limited to a battery, photoelectric cell, or nuclear generator (e.g., a nuclear reactor). A power-receptive target can convert part of the energy from the tractor beam into power, for example, electrical power. An unpowered target has no power system. A powered or power-receptive target can autonomously alter its own position to favorably receive a tractor beam, or to send, for example, information about attitude, pitch, position, velocity, or other physical parameters back to the beam source for feedback. An unpowered target can be more difficult to manipulate, especially at long distances; however, unpowered targets are often the sort for which tractor beams may be most useful.

Tractor beam-like effects can be achieved by coupling thrusters to photoelectric cells under irradiation by remote laser beams; that is, in power-receptive targets. This system can produce remote manipulation, yet the beam does not itself impart significant impulse as does a tractor beam as described herein.

A distinguishing characteristic of a tractor beam system follows from whether or not the target is cooperative. Science fiction tractor beams are frequently applied to uncooperative targets (i.e., targets that are themselves powered and actively trying to work against the remote control imposed by the tractor beam). The ability to manipulate uncooperative targets has obvious and various applications. The closest approach so far may be magnetic levitation; for instance, several small animals were levitated in laboratory studies using intense magnetic fields, including frogs and mice, and one may infer uncooperative targets, at least in the case of the mice (the mice were reportedly “agitated”, and occasionally, with effort, managed to briefly remove themselves from the field). Passive targets, such as meteorites or orbital space debris, are of interest for tractor beam application and the challenges are similar as for uncooperative targets. A third possibility is modifying the target to more readily enable application of a tractor beam.

Application

Laser ablation propulsion may be used for precise placement, attitude control, orbit raising and lowering, and remote positioning of a space object. A space object includes, but is not limited to a satellite, spacecraft, telescope, astronaut, asteroid, space debris, and equipment, such as a tool, tool case, satellite, or astronaut gear. The space objects can be singular or arrayed, such as, for example, arrayed satellites or arrayed telescopes.

In general, such laser ablation propulsion does not require high thrust. Many applications need precise operation, implying low thrust or small impulse bit, and laser propulsion can match those requirements. If properly designed, a laser propulsion engine can deliver higher Iₛₚ than virtually any other propulsion technique, and can operate on an indefinite timescale (as long as the propellant lasts), since its propulsive power is supplied from outside of the spacecraft. The laser ablation propulsion tractor beam can provide new mission opportunities and can enhance control, safety and redundancy in existing space missions.

Conventional propulsion systems are adequate to deploy targets to a chosen location. If used intelligently in coordination with communications systems, they can be used to effect remote control on powered spacecraft. A laser-based tractor beam system, by contrast, is capable of remote control on unpowered targets, which finely adjust or support the propulsion system. Once developed further, such a tractor beam could stand alone as the primary propulsion system.

Laser propulsion allows deployment with virtually no propellant (fuel) storage at the craft. The physics of pulsed ablative laser deployment has been generally established. For various propellant types operating in repetitively pulsed mode, the Beer's law model can give reasonable predictions for ablation behavior, such as mass removal and impulse per pulse:

$$\begin{matrix}m \approx \frac{ρ}{α} ln ξ , and & ( 1 ) \\ I \approx \sqrt{2 m {ΠΦ}_{a} ( ξ - 1 )} , & ( 2 )\end{matrix}$$

where Π represents the geometric collimation of the exhaust (in theory varying from ½ to unity) and ξ=χΦ/Φₐ. χ is a transmission term accounting for attenuation and reflection as the laser pulse enters the target (propellant). Note that in general Φₐ has been reported in the literature as χΦₐ.

If the laser is operated over some time interval Δt between pulses, the average mass removal and thrust are obtained, respectively, by dividing (1) and (2) by Δt. A large enough Δt is chosen to minimize heating and problems in the propellant and/or craft and to avoid absorption by the exhaust plume from the previous shot. Assuming steady consumption, the propellant is entirely consumed at a time t_{f} after N_{f} shots have been delivered, and the propellant lifetime is:

$${t}_{f} = {N}_{f} Δ t = \frac{{m}_{p}}{m} Δ t = \frac{α {m}_{p} Δ t}{ρ {a}_{S} ln ξ} . \qquad ( 3 )$$

Neglecting accumulation effects and cratering, the total impulse delivered is independent of Δt, thus:

$${I}_{tot} \approx {N}_{f} I = {m}_{p} \sqrt{\frac{2 ρ {a}_{S}}{α} ln ξ ( ξ - 1 )} . \qquad ( 4 )$$

So far, beam divergence effects have been neglected, but such effects are critical in this construction. For a Gaussian beam, the spot area varies with z as:

$$a ( z ) = {π ( w ( z ) )}^{2} = π {w}_{L}^{2} ( 1 + \frac{{z}^{2}}{{x}_{0}^{2}} ) = π ( {w}_{L}^{2} + \frac{{z}^{2} {λ}^{2} {M}^{4}}{{π}^{2} {w}_{L}^{2}} ) . \qquad ( 5 )$$

Thus, the fluence of the laser pulse decreases with increasing z. Neglecting attenuation along the laser beam path, the average fluence-dependence in the beam at distance z is given by:

$$Φ ( z ) = \frac{π {w}_{L}^{2} E}{{π}^{2} {w}_{L}^{4} + {z}^{2} {λ}^{2} {M}^{4}} \qquad ( 6 )$$

At sufficiently long range (i.e., z>>πw_{L}²/λ), this expression reduces to:

$$φ ( z ) \approx \frac{π {w}_{L}^{2} E}{{z}^{2} {λ}^{2} {M}^{4}} . \qquad ( 7 )$$

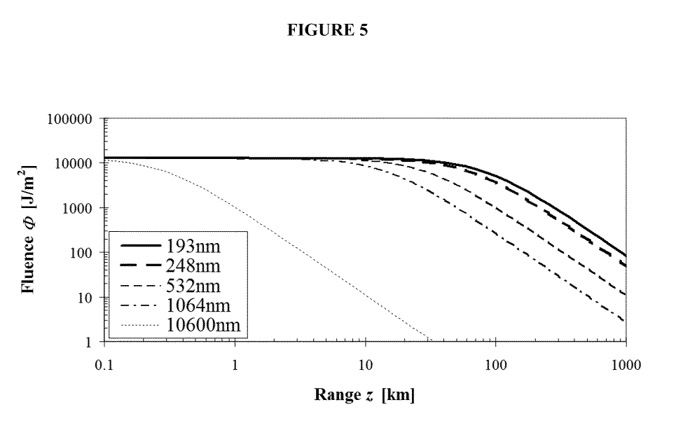

For a constant-area laser tractor beam target, energy scales as the product of that area and (7). FIG. 5 illustrates the general tendency in Φ(z). Examples of lasers suitable for the tractor beam system can be selected from the group consisting of ArF (λ=193 nm), KrF (λ=248 nm), frequency-doubled Nd:YAG (λ=532 nm), Nd:YAG (λ=1064 nm), and CO₂ (λ=10.6 μm) lasers. Laser pulse energy is about 100 J, and an about 10-cm diameter total output aperture can be used for a small, space-based laser station. M²≈2 is used for all wavelengths except 10600 nm, for which M²≈10 has been used.

The laser beams described in FIG. 5 evidence a downward trend that approaches a slope equivalent to 1/z² in the far field. This trend seriously limits long-range space applications, and implies that small wavelengths are preferable. The fluence must remain above the ablation threshold for significant propulsion to occur. In FIG. 5, a sharp drop-off above about 100 km would set the practical limit for reliable operation. In practice, M² may be better or worse for a given high energy laser system, so the effective range can differ.

Onboard focusing optics to concentrate the laser beam at the target can be essential for a fielded system. The thermal ablation thresholds of laser ablation propulsion propellants are commonly about 10³ to about 10⁵ J/m², depending on the material, laser pulse length and laser wavelength. Thus, at long range, it is impossible to avoid the use of concentrating optics at the target, and focusing is limited primarily by beam quality and wavelength. Fresnel lenses and thin mirrors are appropriate for space-based laser propulsion concentration optics due to their light weight, adaptability and low cost. In the case of an ultraviolet laser source, single photons can degrade optics and propellant, which can damage the spacecraft; thus, UV-resistant materials (e.g., those with large bandgap) in the optics of both the laser source and target may be desirable. Such materials are already commonly used for traditional laser ablation applications.

Even with the best optics, the energy captured by the target must be of a practical magnitude for remote control; at long range, the captured energy is proportional to the area of the target. Laser systems are characterized by a beam quality factor M², which appeared in equations (5)-(7) as M⁴. The effect of increasing M² is twofold in the types of laser propulsion targets herein. First, during beam delivery to the target, the divergence of the laser beam increases the spot size, reducing the fluence at the target as in equation (6). Second, when concentrating optics are used at the target, the diffraction-limited spot size increases, reducing the fluence at the propellant surface. Both effects are impediments to achieving long-range laser propulsion, the first by decreasing the total energy available to the craft, and the second by limiting the achievable fluence for a given input energy. As for the diffraction-limited (on-axis) spot size, aₛ=πwₒ², where:

$${a}_{S} = π {w}_{0}^{2} = {π ( \frac{1.22 f λ {M}^{2}}{2 {w}_{T}} )}^{2} . \qquad ( 8 )$$

In this form, w_{T}, is the effective aperture radius of the propulsion target. For example, if the target is of the parabolic type, with a 1-meter aperture, and focuses light onto a central, cylindrical ablator, w_{T}=0.5 m and the minimum achievable spot diameter is about 0.6λM². Although high power and reasonable pulse repetition frequency can be achieved with CO₂ lasers, typically M²>10. For Nd:YAG and excimer lasers, M² is typically much closer to 1, thus these lasers have the potential to be more useful for a laser ablation tractor beam system operated at long range. Small wavelength also works in favor of producing small spot sizes. In any case, λ should be specified along with M² during discussion of a particular system. When the results of equations (7) and (8) are paired, the following result is found for beam delivery:

$$Φ ( z ) = \frac{{E}_{cap}}{{a}_{S}} = \frac{{a}_{T} {Φ}_{T} ( z )}{π {w}_{0}^{2}} \approx \frac{4 π {w}_{L}^{2} {w}_{T}^{4} E}{( {π}^{2} {w}_{L}^{4} + {z}^{2} {λ}^{2} {M}^{4} ) ( 1.488 {f}^{2} {λ}^{2} {M}^{4} )} , \qquad ( 9 )$$

which at long range reduces to:

$$Φ ( z ) \approx 8.54 \frac{{w}_{L}^{2} {w}_{T}^{4} E}{{z}^{2} {f}^{2} {{λ}^{4} ( {M}^{2} )}^{4}} . \qquad ( 10 )$$

The fluence on target is reduced when the laser wavelength, beam quality factor, range, and concentrator focal length are increased. The fluence on target is increased when the laser pulse energy, laser output aperture, and target energy capture radius increase. Small wavelengths, low beam quality factor, short concentrator focal length, and large apertures on both the source laser and the laser propulsion target must be chosen for operation at long range. In practice, the reflectivity of the target surface will also enter into the expression.

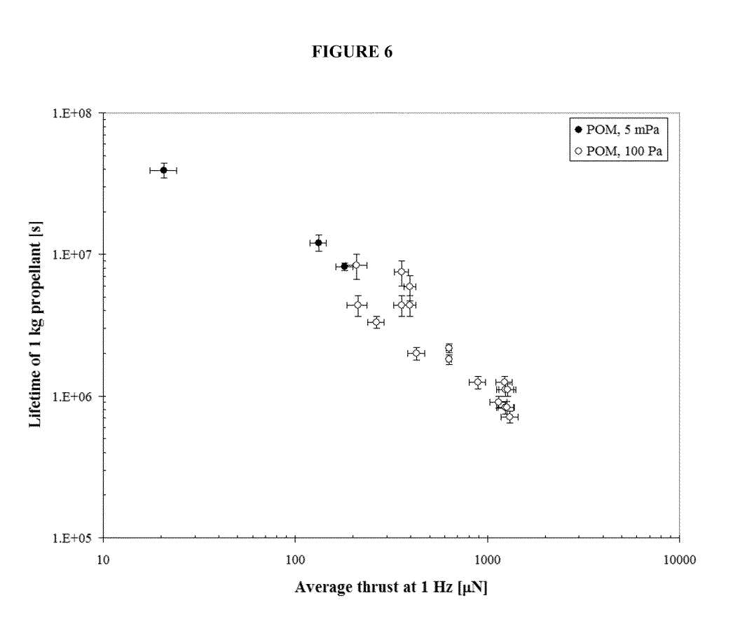

FIG. 6 extrapolates the lifetime of 1 kg of propellant from experimental results in vacuum for direct, unconfined CO₂ laser ablation of a flat plate polymer propellant using constant m and I. These data give an estimated lower bound on performance (in practice, ablation confinement may be used to enhance thrust), and represent realistic values for driving mode propulsion in non-optimal conditions. With the addition of confinement to boost thrust and Iₛₚ, greater lifetime would be expected in a real system, particularly in traction mode. For the polyoxymethylene propellant in FIG. 6, at least about 1 kNs total impulse delivery could be expected over the lifetime of the driving mode propellant.

The range of possible values for Δv for this system is examined to compare it with traditional propulsion systems, and to determine feasible space missions. The rocket equation has:

$$Δ v = {v}_{e} ln \frac{{m}_{p} + {m}^{*}}{{m}^{*}} = {I}_{sp} g ln \frac{{m}_{p} + {m}^{*}}{{m}^{*}} . \qquad ( 11 )$$

For example, a 100 kg payload and a 100 kg POM propellant mass, taking λ=10.6 μm and using Iₛₚ of about 1000 s, which is easily achievable by propellant confinement, provides a Δv≈, 6.9 km/s. In practice, FIG. 6 is inaccurate due to changes in the fluence with range. In that case, the pulse rate is also an important parameter, since fluence decreases at long range.

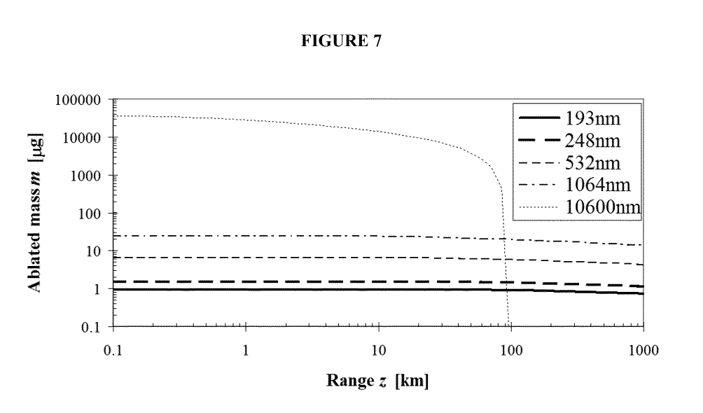

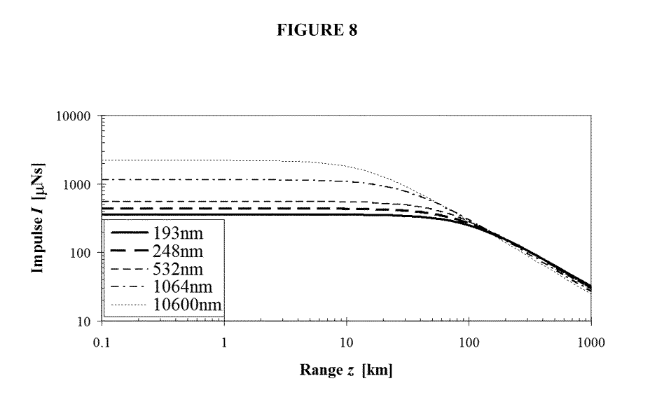

Assuming a photochemical mass removal model, fixed target size, fixed concentrator focal length, and more typical M² values, then mass removal and impulse are expected as shown in FIG. 7 and FIG. 8, respectively. The expected values of mass removal and impulse as functions of range are given by:

$$\begin{matrix}m ( z ) = \frac{ρ {a}_{s}}{α} ln ( \frac{8.54 {w}_{L}^{2} {w}_{T}^{4} E}{{z}^{2} {f}^{2} {{λ}^{2} ( {M}^{2} )}^{4} {Φ}_{a}} ) and & ( 12 ) \\ I ( z ) \approx \sqrt{\frac{2 Πρ {a}_{s}}{α} ( 8.54 \frac{{w}_{L}^{2} {w}_{T}^{4} E}{{z}^{2} {f}^{2} {{λ}^{4} ( {M}^{2} )}^{4}} - {Φ}_{a} ) ln ( \frac{8.54 {w}_{L}^{2} {w}_{T}^{4} E}{{z}^{2} {f}^{2} {{λ}^{2} ( {M}^{2} )}^{4} {Φ}_{a}} )} . & ( 13 )\end{matrix}$$

Assume the following experimental conditions: E=100 J, M²=2 (except for the CO₂ laser, where M²=10), f=w_{T}=w_{L=0.1} m, ρ=1500 kg/m³, Π=0.8, τ=1 ns, Φₐ≈10³ J/m², and α=10⁵ m⁻¹ (indicative of strong absorption).

For deployment, ablation at the target produces exhaust directed towards the laser source, driving the vehicle away by momentum conservation. It may be necessary to clean or replace the laser source optics after long periods of operating in this configuration due to, for example, deposition of exhausted material on the optics. A system can be designed to enhance impulse by confinement between propellant layers, against a substrate, within a nozzle structure, or some combination of these techniques.

Space Debris Removal

Orbital space debris poses a serious hazard to space stations, satellites, astronauts and spacecraft, and reduces the lifetime and functionality of in-space systems. When discussing how to approach space debris, the size of the object is a major deciding factor. For small particles, targeting a wide region of space over a long period of time may be feasible, but it does run the risk of interfering with or disabling existing satellites. For large objects (about 10 cm or larger) these methods may not be feasible, because ablative thrust from diffuse, low-fluence irradiation may be insufficient to significantly affect the orbits of the objects over reasonable timescales.

One possible solution for large objects is to tag them with an inexpensive, cooperative thrust system that can then be targeted by an external energy source to allow remote control and removal of the object from orbit. Rendezvous of this kind of cooperative target system with actual target objects can be a significant challenge. On the other hand, once tagged, an object can be targeted over a long period of time, potentially accumulating significant thrust. One solution is to use a small, cheap, rocket-propelled interceptor to bring the cooperative system into the orbit of the target object and facilitate attachment.

A driving mode de-orbit mission can be used to raise a target's orbit into a higher eccentricity, wherein use of a cooperative target is unnecessary. Over time, resulting atmospheric drag, especially at perigee, pulls the object from orbit. Ideally, such entrance utterly destroys the entering object to avoid casualty or damage to structures on the ground. Space debris removal missions have undergone extensive conceptual development and feasibility studies and have already been promoted in several countries. Space debris poses a significant threat to space resources and astronauts in orbit, and is within the range of mass that can be effectively addressed by a laser tractor beam. If a specific large piece of debris were judged to be particularly hazardous, a targeted attachment can facilitate de-orbit.

Deployment of space probes can be achieved using a laser station, reducing the need for heavy conventional propulsion systems, yet achieving the same end. As a result, more payload can be carried, including scientific instruments, to enhance the value of missions. For instance, multiple probes could be sequentially launched from a laser mothership towards meteors, comets, moons, planets, the sun, regions of interplanetary dust, or sub-regions of these celestial objects. In general, the probe is not expected to return to the mothership.

To ensure the long-term survival of humanity, a need exists to effectively combat the hazard posed by large asteroids and comets on approach to Earth. The large size of these objects is probably beyond the present limits of mass at which significant control can be achieved by beamed energy, unless the object is detected significantly in advance of its arrival at Earth. Future advances in laser technology may deliver a device capable of deterrence and, due to the catastrophic implications of the arrival of a “death asteroid”, it seems wise to make preparations for mitigation and deflection, such as with the laser tractor beams described herein.

Asset Retrieval

A laser propulsion tractor beam can enable missions that are difficult or impossible with conventional propulsion systems. For example, an astronaut might lose contact with a spacecraft or space station during a routine spacewalk, due to carelessness, equipment failure, a medical condition, or some unforeseen cause. Further protection is typically provided by a tether and/or extravehicular activity (EVA)-type thrusters onboard the spacesuit. In some extreme cases, such equipment can fail, leaving the astronaut drifting inexorably from the station or ship. But, if the spacesuit is equipped with an emergency laser ablation tractor beam target (and with appropriate eye protection), retrieval from the station or spacecraft can occur within a few minutes, well within the limits of the astronaut's air supply and in time for any needed medical attention. Although a system for unaided steering is simplest, an astronaut can provide cooperative steering, reducing the need for complex systems to handle the task.

An astronaut can float away from the initial position at the spacecraft with a relative velocity of about 1 m/s. Use of higher fluence and lower-Iₛₚ propellant are justified in this situation, and the relative short range (up to about 1 km) of this maneuver suggests the use of a diode array at high efficiency and high power, with virtually no divergence-related losses in the beam within the working range. A fast laser pulse repetition rate may also be used. For instance, 1 kg emergency propellant used in a confined mode for a coupling coefficient of 500 μNs/J, with 100 J pulse energy at 20 Hz produces an average thrust of about 1 N, which is sufficient to accelerate a stationary 200 kg astronaut (including the weight of the EVA suit) to about 1 m/s in about 200 seconds. In 2000 seconds, or about 30 minutes, the astronaut could be accelerated through about 10 m/s, which is sufficient to recover the astronaut given the expected initial velocity. In such maneuvers the astronaut should not be accelerated to velocities that can result in injury upon collision with the spacecraft. For added safety, laser ablative braking in driving mode can be used as the astronaut approaches the ship. In terms of Δv, an unconfined, established laboratory value is a lower limit. Using values for flat plate ablation, Iₛₚ of about 200 s and Δv of about 20 m/s is reasonable. An emergency beamed energy system can increase safety by providing a redundant backup system for retrieval and protection of the most valuable space assets.

Tools are sometimes lost or dropped during EVAs or similar missions. Such items are usually specially designed and extremely expensive. If tools or bags containing tools deployed in an EVA mission were fitted with a deployable laser propulsion tractor beam target, any loose tools can be returned to the station with minimal trouble. To avoid interference with mission tasks, the target can, for example, be active, remaining in a standby state to be deployed upon receiving a remote signal from the station or automatically, after a time limit or when not in use. A typical tool might weigh only 1 kg or so, which is much lighter than a satellite or astronaut, and thus a less-powerful laser system is needed to retrieve the tool. At long range, relative velocities of the tool and spacecraft can be large. Braking by driving mode laser ablation on the cooperative target can prevent hazardous impact of the tool against the station or other space object.

Technical challenges to de-orbiting existing debris are severe, and any traction-based laser propulsion methodology requires a cooperative target on the debris. Some existing structures, such as solar sails, can be used as cooperative laser tractor beam targets, but survival long enough to significantly assist with de-orbit is questionable. Under long-term or high-power irradiation, breakup of components can occur, producing additional debris. Similar challenges face driving-thrust mode laser ablation propulsion de-orbiting, but without the benefits, since fraction mode de-orbit generally requires cooperative targets.

If cooperative targets were installed on satellites before launch, a beam of energy from the ground could illuminate such satellites in traction mode, pulling the debris into an orbit of higher eccentricity and thereby intensifying the effects of atmospheric drag for de-orbit. This approach does not solve the problem of current space debris, since such satellites lack cooperative targets, but it is a practical solution for responsibly managing future space debris.

Space satellites suffer a variety of minor but mission-endangering problems, such as sticking valves, propellant leaks, and malfunctioning batteries. In many cases, a simple repair can reestablish functionality. In some cases, the high cost or special value of a satellite system might justify the launch of a separate repair satellite into an orbit close to that of the first. If at least one of the satellites were equipped with an onboard laser station, and at least the other station were equipped with a cooperative laser tractor beam target, the two craft can be brought together and docked to facilitate repair of the damaged satellite. Less risk is involved if the repair satellite is equipped with a laser, since the satellite to be repaired might be nonfunctional, and in that case, a cooperative target will function even if the satellite does not. The laser system is used to steer, align, accelerate, and brake the craft to facilitate docking.

This same laser tractor beam technology can be used to deploy and later retrieve various types of probes, for example including direct sampling of mineral or gas compositions in the atmosphere of a celestial body of interest (e.g., Mars, comets, the rings of Saturn, or interplanetary gases), or satellite-like surveillance systems. Another possibility is soft-landing of sampling probes onto the surfaces of comets or small asteroids for exploration or sampling purposes, followed by retrieval.

Explorers on Earth have stored supplies since ancient times to increase their chances of survival. As the modern frontier of exploration, space should be no different. Such stores can take the form of emergency equipment fitted with cooperative targets, launched into convenient orbital positions around the Earth or other astrophysical objects. If a spacecraft with a laser tractor beam system is launched into a similar orbit, the supplies can be retrieved if needed. Such supplies can include propellant, an emergency re-entry-capable “lifeboat”, compressed oxygen or air, food, water, batteries, medical supplies, and other equipment useful for emergencies. This protocol can enhance mission safety.

In many cases, a sensitive system onboard a satellite requires very fine orientation of the satellite attitude. Examples include, but are not limited to, satellite surveillance systems, communications satellites, and on-orbit telescopes. A cooperative laser tractor beam target can facilitate remote fine adjustment. Because of the low rates of propellant consumption, remote control, and finely adjustable impulse bit, such a system is likely to be a valuable tool for construction of sensitive, arrayed systems.

In order to levitate a macroscopic target on the Earth's surface, significant laser power is necessary. In space, it is much easier to hold the position of a target constant, equivalent to station keeping. Laser ablation propulsion typically has a widely adjustable range of impulse bit and Iₛₚ. Missions such as formation flying, such as an array satellites or an array of telescopes or precise, in-space assembly of large space structures, such as a satellite, spacecraft, space station, or base, for example a lunar base, can use this kind of remote control to enhance the precision, response, and sustainability of maneuvers. Control can be effected from the ground, from a remote space station, or any combination thereof.

A space object may need to be passed in a controlled manner between two space stations. Using a laser at both source and destination allows redundant control over the object trajectory, potentially doubling the imparted impulse to speed the transfer, and at least providing additional safety in case of laser failure during acceleration and deceleration of the object or asset. Because the laser tractor beam allows lateral steering (transverse to the laser beam) as well as longitudinal steering (along the beam), handoff of a space object can also avoid obstacles. This fact is particularly important given the modern context of orbital space debris avoidance.

Although one station is likely to be broadly targeting the other station during the transfer, by using large-area beams and concentration of the beam at the target, irradiance levels can be used which are below the damage threshold of the station. Examples of concentrating targets include, but are not limited to, parabolic nozzles, in-tube targets, bi-paraboloid targets, and onboard laser microthrusters.

Reducing Vulnerability to Malicious Control

One critical point regarding use of a cooperative system for remote control is the possibility of a hostile or malicious agency attempting to take control of the system for their own ends, or to harass or impair the operator of the satellite. To control a vulnerable cooperative target, a hostile agency would first need to determine and use the specific wavelengths and fluence levels wherein the target is cooperative. Since the current laser types capable of long-range, high-power operation are few, as are common operating wavelengths, such action is within the capability of various world governments and corporations. By using appropriate sensors and/or surveillance, the satellite operator can immediately determine the origin of a malicious effort and take steps to mitigate it. One solution to avert this scenario is to hold the cooperative tractor beam target in a non-deployed, standby state until either a coded signal is transmitted to the satellite from its operators, or until the failure of key systems (e.g., power, communications or attitude control) render the satellite defunct. In that case, the target can be deployed automatically, for instance using a “dead man switch” activated on a sufficiently serious threshold level of internal error codes, or on a general power failure of the satellite. The operating agency of the defunct system can then responsibly and safely de-orbit the satellite, reducing accumulation of large space debris and ensuring future human access to space, without taking on any serious risk of hostile manipulation of space assets.

### EXAMPLES

### Example 1

A TEA CO₂ laser (Selective Laser Coatings, GmbH) was used, operating with output energy of about 1 to about 10 J and producing fluence from about 1 to about 100 J/cm² at the target. The laser pulse was directed off two molybdenum mirrors with reflectivity of about 95% to about 98%, and passed through a φ=50 mm aperture in a vacuum chamber, including a ZnSe window (transmission, ≈98%) and a f=30 cm, φ=55 mm ZnSe lens (transmission, ≈98%). The pulse length of the laser has a 90±10 ns full width at half maximum (FWHM) main peak and an about 3-μs tail, measured with a photon drag detector. The laser pulse energy was measured with a Gentec ED-500LIR thermopile energy meter placed between the window and lens, then corrected for transmission through the lens. The laser spatial profile was previously checked by manually scanning at 5 mm intervals with a 5 mm circular aperture and the aforementioned energy detector.

Several first-generation prototype two-layer propellant targets were assembled from films (McMaster-Carr, Chicago, Ill.) of 0.010″ (254 μm) and 0.020″ (508 μm) thick polyoxymethylene (POM) film, 0.040″ (about 1 mm) thick polytetrafluoroethylene (PTFE) film, and 0.040″ (about 1 mm) thick ultra-high molecular weight polyethylene (UHMW PE, or PE) film. The layers of the first-generation targets were attached using a proprietary adhesive layer that came pre-loaded onto one side of the 0.020″-thick POM and 0.040″-thick UHMW PE polymer films. The commercial adhesive layer is very similar to double-sided tape, and includes a polymer film as well as adhesive. The POM and PE polymer film samples were cut by hand into approximately 25 mm×25 mm squares to facilitate target assembly and testing.

Second-generation targets were assembled using a 93% cyanoacrylate adhesive (Loctite®-Cemedine® Zero Time) and the same polymer films as described above, also cut into 25 mm×25 mm squares. To use the polymer films manufactured with the unknown commercial adhesive, the adhesive layer was manually removed from the films by grasping one corner with pliers and slowly pulling it away from the surface, leaving a clean surface on the polymer where the adhesive was previously attached.

The layer compositions, aperture diameters, pulse energies, and focal distances of the various first (Targets 1-4) and second (Targets 5-8) generation targets are as shown in Table 1.

TABLE 1
Energy, spot area, and fluence characteristics for the tests

| Target | Layer 1 | Layer 2 | Adhesive type | D | E | L |
|---|---|---|---|---|---|---|
| Units | [mm] | [mm] | | [mm] | [J] | [cm] |
| 1 | 1 PE | 0.25 POM | commercial (on PE) | 20 | 0.988 ± 0.008 | 20-28 |
| 2 | 1 PE | 0.25 POM | commercial (on PE) | | | 25-28 |
| 3 | 1 PTFE | 0.5 POM | commercial (on POM) | | | 26-28 |
| 4 | 1 PTFE | 0.5 POM | commercial (on POM) | 50 | 8.5 ± 0.1 | 28-29.5 |
| 5 | 1 PE | 0.5 POM | cyanoacrylate | | | 29.5 |
| 6 | 1 PE | 0.5 POM | cyanoacrylate | | | 27 |
| 7 | 1 PE | 0.5 POM | cyanoacrylate | | | 24-26 |
| 8 | 1 PE | 0.5 POM | cyanoacrylate | | | 23 |

Impulse was measured with a custom-built aluminum impulse pendulum. In the case of tractor-beam propulsion, the ablation occurs between the propellant layers, blowing out part of the rear surface of the target; thus, the pendulum bob initially experienced a thrust to the right. For driving-mode propulsion, the ablation occurs on the front surface, therefore in this case, the bob experienced a thrust to the left. Pendulum output has a sinusoidal dependence, which abruptly shifts in phase and amplitude when an ablation event occurs. CO₂ laser ablation of the targets demonstrates two-layer, direct, cooperative tractor beam impulse generation. Both target types (first- and second-generation) were tested for production of tractor-beam impulse.

### Example 2

### First-Generation Targets

Ablative testing of the first-generation targets began with Target 1, including driving-mode testing of the POM surface, and then tractor-beam mode testing at high fluence (the target was removed and reversed in the holder between these tests). Due to the high fluence used, the PE layer was also ablated in driving mode during this test. Finally, a hole was laser-drilled through the PE layer, after which confined ablation produced significantly higher driving impulse, but thereafter negated any subsequent tractor-beam-mode use of the target.

Initial testing produced only driving mode impulse, because the energy delivered was insufficient to fully separate the propellant layers, resulting instead in a bubble between the layers. However, by gradually drilling through the POM layer (without significant ablation of the PE layer), a tractor-beam-like impulse was generated from confined ablation at the interface of the layers, exhausted through the hole drilled in the rear surface. A total of approximately 30 pulses were delivered to Target 2 at a variety of focal distances to locate a fluence at which tractor-beam propulsion was operational.

The achieved tractor-beam operation was not direct ablation of the rear layer but resulted from an internal chamber; i.e., a bubble zone between the propellant layers, in the course of delivering many shots at high fluence. In addition, a small exhaust nozzle was drilled through the POM propellant layer. Subsequent shots then ablated POM at the interface, and in the internal heavy confinement limit, the exhaust was directed through the drilled aperture. Therefore, the two-layer propellant created in this case, although capable of being used in both tractor-beam and driving modes, operated by a different mechanism than initially envisioned.

Target 2 was capable of net operation in either driving or tractor-beam mode, based on the incident fluence, as selected by changing the distance between the lens and target. Demonstration of the capability to switch between these modes with a tractor beam system was also important, particularly for application to space missions. Therefore, additional tests demonstrated Target 2 switching between driving and tractor mode within a short time period.

The impulse pendulum was used to record imparted impulse, delivered in both forward and driving modes within several seconds, switched during a single experiment by changing the fluence incident on the target by changing the position of the lens between shots. Two experiments of this sort were made. The pulse energy was about 1 J for both experiments. The results shown in FIG. 4 demonstrate that both reverse and forward momentum can be imparted to the same target within a short time period. In these experiments, the time between the shots required for safely readjusting the position of the lens by hand, clearing the test area, and firing the laser was about 5 to about 10 seconds. In principle, the real limitations are set by the associated propellant feed system and the focusing adjustment necessary for the lens, which can be performed automatically using, for example, an autofocus telescopic system such as that of a modern digital camera.

The polyethylene target suffers conditioning damage when ablated repeatedly. After several shots on the same spot, black spots are seen in the target area, indicating possible carbonization of the material as evidenced from elimination of C—H stretching frequencies of the chain in the attenuated total reflectance infrared spectrum. Carbonization is likely part of the reason that a hole was drilled through the PE layer of Target 1 instead of through the POM layer, as in Target 2.

Targets 3 and 4 were ablated in different conditions, but the results were similar: in neither case was a tractor-beam impulse produced. The low impulse observed with PTFE may be due to high reflectivity at the front surface, so that insufficient radiation is available for significant ablation. In the present case, the implication is that attenuation prevents significant ablation of POM or the adhesive ablation at the central interfaces. At high fluence, ablation of PTFE occurred at the front surface (i.e., in driving mode) without significant separation of the propellant layers.

A circular bubble-like zone formed around the ablation site for both Targets 1 and 2. Separation of the two propellant layers was evident in this zone within a radius of about 1 to about 5 mm. This occurred even though the target was clamped tightly into the holder at its edges, indicating that significant pressure was formed at the interface; i.e., a large fraction of the radiation successfully passed through the first propellant layer without significant ablation, and deposited most of the pulse energy at the interface. The separation in the first-generation targets appeared at both low and high fluence. The adhesive was not strong enough, so the layers separated before significant pressure build-up could occur.

### Example 3

### Second-Generation Two-Layer Targets

The new targets were bonded using Zerotime™ cyanoacrylate adhesive, by applying a single drop to one film layer resting on a table, immediately dropping the second layer onto the first, and applying pressure to the center of the top layer. Because of the rapidity at which the adhesive hardened, these targets were not perfectly level, and sometimes the adhesive did not have time to spread to all corners before hardening. Thus, some areas are without adhesive.

Ablation of these targets was conducted using about 8.5 J pulse energy, with the intent of locating the fluence regime to best support tractor-beam impulse generation and avoid hole-drilling effects seen with the first generation targets. The nominal fluence (energy divided by spot area, neglecting shielding effects from plasma) was set from about 20 J/cm² to about 1000 J/cm².

The highest fluences were used on Targets 5 and 6, and did not separate propellant layers. This is likely because significant shielding of the target occurred at high fluence. The fluence necessary to induce significant shielding (the critical plasma threshold) was higher for these targets than for ablation of POM. Only driving-mode ablation was produced for Targets 5 and 6, despite some separation of the layers in Target 5. Photography revealed significant ablation plasma at the front surface of both targets.

Only driving mode ablation was produced with Target 7, despite separation of the propellant layers (indicating significant delivery of energy to the interface). A bright blue plasma plume was observed on the front surface.

Target 8 was tested at lower fluence, and dramatically achieved tractor propulsion. The rear POM propellant layer blew apart and fractured into 3 pieces of about 0.5 cm², as well as many smaller fragments. The adhesive directly under the laser spot appeared to stick to the PE layer rather than to the POM layer, indicating that confined ablation occurred between the adhesive and POM layers, and not between the PE and adhesive layers, evidence that the adhesive was effectively transparent to the laser radiation.

For the impulse pendulum, a decrease in voltage corresponded to driving impulse, and increase in voltage to tractor-beam impulse. Significantly higher fluence was used on Targets 5 and 6 than on Targets 7 and 8; correspondingly, the imparted impulse with Targets 7 and 8 greatly exceeded that produced with Targets 5 and 6, and in fact over-ranged the linear displacement sensor.

Both Targets 7 and 8 suffered mechanical damage from the great force generated between the layers while the target was held fixed in its aluminum holder. No such damage was observed to Targets 5 or 6, but the layers separated slightly for Target 5. Insufficient pressure likely formed to push away the absorbing second layer (POM) due to small spot area, compounded by attenuation of the incident fluence by plasma shielding. Ablation of large fragments (e.g., with Target 8) is not desirable from a space debris standpoint; ideally, the propellant produces only ablated gas (e.g., atoms and single molecules up to small polymer chain fragments). Thinner layers in the ablation targets result in a greater proportion of vaporized exhaust and less fractioning.

### Example 4

### Astronaut Retrieval

A station-based reversed-thrust laser system beneficially provides vastly enhanced range, longer operating time, and less bulky mass attached to the astronaut than other methods. The mass of the laser system itself may be significant, but may be used for a variety of purposes besides this emergency application.

Since the first extravehicular activity (EVA) by Aleksei Leonov in March 1965, EVA has become a routine method to repair manned spacecraft. Many EVA activities rely on tethers (with range about 17 m), but untethered EVAs were also made using Manned Maneuvering Units (MMUs). The American MMU, designed for repair missions carried enough N₂ propellant for 6 hours of EVA. Its use was discontinued following the Challenger disaster due to safety concerns, access to cheaper options such as tethers, restraint systems and hand grips, and moving the orbiter. A Soviet EVA backpack, the UPMK, had similar operational parameters. The MMU was eventually replaced by the Simplified Aid for Extravehicular Activity Rescue (SAFER)—for emergency use only—which remains in service on the International Space Station. A collection of proven MMU strategies is shown in Table 1 along with the estimated properties of a reversed-thrust target.

TABLE 2
Key characteristics of major MMU units

| System | Mass [kg] | Δν [m/s] | Range [m] |
|---|---|---|---|
| MMU | 153 | 20-25 | 137 |
| UPMK | 218 | 30 | 60-100 |
| SAFER | 29.48 | 3 | 15 |
| Reversed thrust target, | 10 | 10 | 10,000 |
| estimated | | | |

Tethers and gas thrusters are rarely intended to operate beyond a range of 100 m. In the extreme case where safety measures fail, an astronaut can be left floating away, and retrieval efforts limited to 100 m might be too late. An EVA spacesuit, for instance the American Extravehicular Mobility Unit (EMU), carries 6-7 hours of breathable air, but an accident need not occur at the beginning of an EVA. The option of a laser-based retrieval system is highly attractive for its increased range and ability to be used for a variety of remote control missions, not merely for emergency astronaut retrieval.

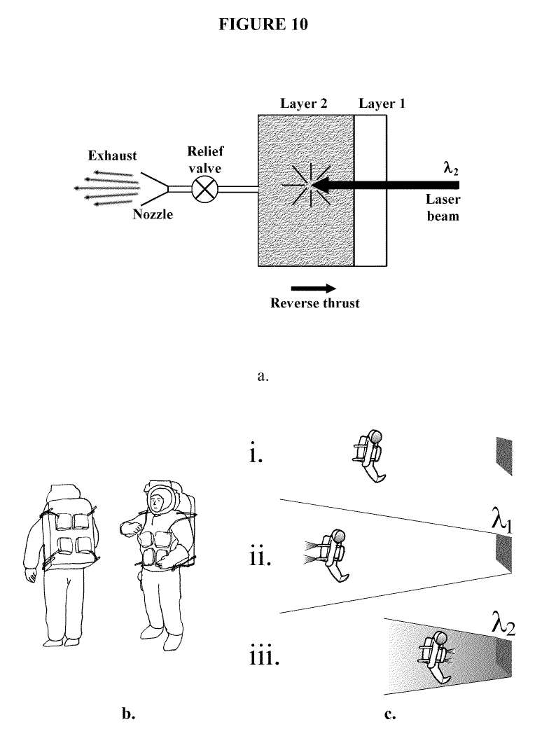

A suit retrieval target has minimal weight and bulkiness. For the source laser, a minimal footprint on the station is best, in terms of power consumption, storage space and weight. One possible form for a reversed-thrust target is overlapping propellant bladders shaped as part of the suit, possibly also serving as padding and thermal insulation when not in use for propulsion. This device and its implementation are shown in FIG. 10.

The main cavity of each packet holds a quantity of porous propellant which absorbs strongly at wavelength λ₁, producing gaseous exhaust. Similar to a heat exchanger thruster, irradiation results in pressurization and energetic expulsion of the propellant exhaust down a thin exhaust channel, as shown in FIG. 10a, which could be terminated by a pressure relief valve. The channels exhaust on the other side of the suit, producing reversed-thrust propulsion. Many targets are attached around the suit, compensating for the relative orientation of the laser and the astronaut—a floating astronaut can be illuminated from any side, yet be drawn towards the laser. By placing the laser system in a suitably designed air-lock or cargo bay, an astronaut could be retrieved automatically, without any direct human aid or intervention; thus, risk factor to other crewmates is reduced compared to an EVA rescue using the SAFER system. This function can be performed remotely by mission personnel on the Earth, or as an automatic safety function of an onboard computer. Retrieval to the station or spacecraft within a few minutes is possible, well within the limits of a suit air supply and likely in time to deliver necessary medical assistance.

On the station, a laser has high power—for operation at close range (e.g., within 1 km) divergence is not a serious concern—and a CO₂ laser or an array of laser diodes are appropriate. Cheap, light, high-power laser diodes are commercially available at optical wavelengths (e.g., 808 nm); thus, a diode array is attractive and can be implemented as either a pulsed or continuous system.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

What is claimed is:

1. A method of using a remote laser source to manipulate a space object having a target, comprising:
projecting a beam from the remote laser source, wherein the beam has a sufficient intensity and wavelength to cause ablation at a position on the target;
imparting an impulse to the space object having the target;
modifying at least one beam characteristic selected from the group consisting of intensity, wavelength and position on the target, wherein the position and/or orientation of the space object is altered relative to the remote laser source.

2. The method of claim 1, wherein the space object is pushed relative to the remote laser source.

3. The method of claim 1, wherein the space object is pulled relative to remote laser source.

4. The method of claim 1, wherein a torque is applied to the space object relative to the remote laser source.

5. The method of claim 4, wherein the torque turns the target into a proper alignment with the beam.

6. The method of claim 1, wherein a thrust directional parity of the target is switched.

7. The method of claim 1, wherein at least a first remote laser source projects a first beam and at least a second remote laser source projects a second beam.

8. The method of claim 7, wherein the first beam has at least a different intensity, wavelength, or position on the target than the second beam.

9. The method of claim 8, wherein the target comprises a first layer that is transparent to the wavelength of the first beam.

10. The method of claim 8, wherein the target comprises a first layer of transparent solid material comprising an array of microlenses, and a second layer of solid material which is absorbing at a beam wavelength.

11. The method of claim 8, wherein the target comprises a first layer with a high threshold fluence for ablation, and a second layer with a low threshold fluence for ablation.

12. The method of claim 11, wherein the first layer comprises one or more selected from the group consisting of polyethylene, polyethylene terepththalate and polytetrafluoroethylene, and the second layer comprises one or more selected from the group consisting of polyoxymethylene or polychlorotrifluoroethylene.

13. The method of claim 11, wherein the first layer and the second layer are joined together by an adhesive.

14. The method of claim 11, wherein the remote laser source has a wavelength of 10.6 μm.

15. The method of claim 1, further comprising transmitting information between the remote laser source and the space object.

16. The method of claim 1, wherein the space object is selected from the group consisting of satellite, spacecraft, telescope, astronaut, space debris, asteroid, equipment, tool, arrayed satellite and arrayed telescope.

17. The method of claim 1, wherein the remote laser source comprises a diode laser; a dye laser, a solid state laser selected from the group consisting of Nd:YAG, Er:YAG, Nd:YLF, Nd:YCa₄O, Nd:Glass, Ti:sapphire, Tm:YAG, Ho:YAG, Ce:LiCAF, U:CaF₂, Sm:CaF₂ and Nd:YVO₄; or a gas laser selected from the group consisting of CO₂, CO, F₂, N₂, KrF, Ar₂, Kr₂, Xe₂, ArF, KrF, XeBr, XeCl, XeF, and KrCl.

18. A method of using a remote laser source to manipulate a space object having a target, comprising:
projecting a first beam from a first remote laser source, wherein the first beam has a sufficient intensity and wavelength to cause ablation at a position on the target;
projecting a second beam from a second remote laser source, wherein the second beam has a sufficient intensity and wavelength to cause ablation at a position on the target, and wherein the second beam has at least a different intensity, wavelength or position on the target than the first beam;
imparting an impulse to the space object having the target;
modifying at least one beam characteristic selected from the group consisting of intensity, wavelength and position on the target, wherein the position and/or orientation of the space object is altered relative to the remote laser source;
wherein the target comprises a first layer and a second layer.

19. The method of claim 18, wherein the first layer comprises one or more selected from the group consisting of polyethylene, polyethylene terepththalate and polytetrafluoroethylene,
the second layer comprises one or more selected from the group consisting of polyoxymethylene or polychlorotrifluoroethylene, and
the first layer and the second layer are joined together by an adhesive.

20. A system comprising:
a remote laser source;
a space object having a target comprising a first layer and a second layer;
a means for projecting a beam from the remote laser source, wherein the beam has a sufficient intensity and wavelength to cause ablation at a position on the target;
a means for imparting an impulse to the space object having the target;
a means for modifying at least one beam characteristic selected from the group consisting of intensity, wavelength and position on the target, wherein the position and/or orientation of the space object is altered relative to the remote laser source.
